(19) United States
(12) Patent Application Publication
(10) Pub. No.: US 2025/0037406 A1
(43) Pub. Date: Jan. 30, 2025

(54) ARRANGEMENT FOR A DRIVER ASSISTANCE SYSTEM

(71) Applicant: SAINT-GOBAIN GLASS FRANCE, COURBEVOIE (FR)

(72) Inventors: Michele CAPPUCCILLI, HERZOGENRATH (DE); Jefferson DO ROSARIO, HERZOGENRATH (DE); Varun RAMESH KUMAR, HERZOGENRATH (DE); Markus KEWITZ, HERZOGENRATH (DE); Andreas GOMER, HERZOGENRATH (DE)

(21) Appl. No.: 18/696,864

(22) PCT Filed: Sep. 7, 2022
(86) PCT No.: PCT/EP2022/074889

§ 371 Date: Mar. 28, 2024

(30) Foreign Application Priority Data
Sep. 29, 2021 (EP) 21199929.7

(51) Int. Cl. G06V 10/14; G06V 20/59; H04N 23/20

(52) U.S. Cl. CPC G06V 10/14; G06V 20/597; H04N 23/20

(57) ABSTRACT

An arrangement for a driver assistance system of a vehicle, includes a radiation source for emitting infrared radiation, a radiation receiver for receiving infrared radiation, a windshield formed of an outer pane and an inner pane which are connected to one another via a thermoplastic intermediate layer, wherein the windshield has at least one functional layer reflecting infrared radiation, wherein the radiation source is arranged such that infrared radiation can be reflected from the functional layer as first reflection radiation onto the face of a driver, the first reflection radiation can be reflected from the face of the driver as second reflection radiation onto the functional layer, and wherein the radiation receiver is arranged such that the second reflection radiation reflected from the functional layer as third reflection radiation can be reflected to the radiation receiver and received by the radiation receiver.

The invention relates to an arrangement having a windshield, a radiation source for emitting infrared radiation and a radiation receiver for receiving infrared radiation for a driver assistance system of a vehicle, which enables infrared-based monitoring of the driver. Furthermore, the invention relates to a driver assistance system of a vehicle having such an arrangement, and to a method for monitoring the driver of a vehicle.

Modern vehicles are often equipped with electronic driver assistance systems that support the driver in guiding the vehicle, for example by automatically applying the brakes if there is a risk of a collision or automatically keeping in a lane if the vehicle leaves the lane. Such driver assistance systems have proved very successful in practice, in particular if they have a monitoring function for the driver, for example to recognize driver fatigue at an early stage, but also to recognize excessive distraction from safe vehicle operation, for example by operating a cell phone.

For this purpose, it is known to scan the driver's face and in particular his or her eyes using infrared radiation, which is not visible to the naked eye and thus does not disturb the driver and other vehicle occupants. Thereby, complex algorithms may be used to capture the driver's gaze direction and duration, which can indicate fatigue, for example, if the duration of gaze in a particular direction is unusually long (staring gaze). On the other hand, an averting of one's gaze from the direction of travel that is too frequent can indicate distraction. It is also possible to recognize facial expressions, which can also give an indication of the driver's condition.

With reference to FIGS. 1 to 3, driver assistance systems 100 which are known in the prior art are schematically illustrated in motor vehicles which enable monitoring of the driver with the aid of infrared radiation. FIG. 1 shows a driver 3 at the steering wheel 4 of a vehicle 2, of which only the front part including the windshield 5 and the console 6 is shown.

DE 10 2014 115958 A1 discloses a system for monitoring a driver of a vehicle. The system is based on an infrared flash for generating an infrared light on the driver and an infrared camera for capturing a reflection.

EP 1 333 410 A2 discloses a device for gaze tracking in combination with an HUD system which has an illumination device and a reflection device.

WO 2016/184732 A1 discloses a pane comprising a substrate and a coating that reflects heat radiation on an interior-side surface of the substrate.

Such driver assistance systems 100 always comprise a radiation source 7 for emitting infrared radiation and a radiation receiver 8 for receiving infrared radiation, which are typically independent components which, however, are usually arranged in the same assembly. The radiation source 7 is always arranged such that the infrared radiation is directed directly onto the face 23 and in particular the eye region of the driver 3. The infrared radiation is reflected from the face 23 of the driver 3 and then detected directly by the radiation receiver 8 (e.g., camera). The radiation source 7 and the radiation receiver 8 are here attached, for example, to the rear-view mirror 17 of the vehicle 2.

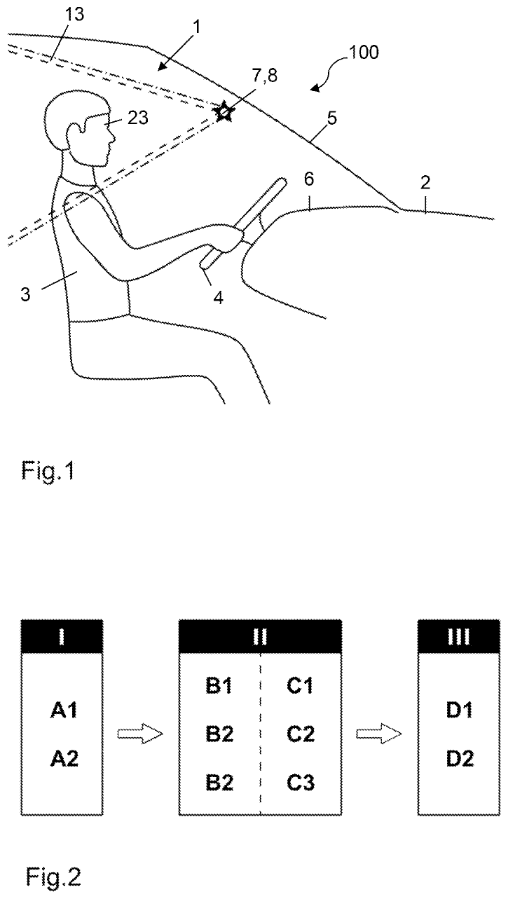

FIG. 2 schematically illustrates the functional components of such driver assistance systems 100 with a monitoring function for the driver on the basis of infrared beams. Here, block I represents the portion of the driver assistance system concerning the application of infrared radiation, block II represents the processing of the signal data recorded here to determine information about the driver, and block Ill represents possible actions based on the determined information about the driver.

Specifically, infrared radiation is emitted in block I, step A1, by the radiation source 7 in the direction of the face of the driver 3, and in step A2 the infrared radiation reflected from the face of the driver 3 is received directly by the radiation receiver 8. In block II, which is implemented in the vehicle 2 by an electronic control unit (ECU), information about the driver 3 is determined using algorithms known per se, in this case, for example, a head position (B1) and an eye position (B2) of the driver 3. In addition, identification (B3) of the driver 3 is performed, for example, on the basis of preset personalized driver data. In addition, suitable algorithms can be used to determine further information about the driver 3, such as the presence of fatigue or drowsiness (C1), which can be recorded in particular on the basis of a reduced frequency of eye movements, or excessive distraction (C2) of the driver 3, which can be recognized, for example, by directions of gaze that are not primarily directed forwards and thus do not serve to guide the vehicle. The driver state thereby determined can in particular also be subjected to personalization (C3) in order to be able to determine driver-specific information, which presupposes that the driver (B3) has been identified. In block III, as a result of determining information about the driver using actuators, an intervention in the vehicle guidance may be performed. For example, a steering intervention for lane keeping takes place when fatigue, in particular microsleep, has been detected in the driver. Alternatively or additionally, an acoustic and/or visual signal can be output by a signaling device, for example a visual indication that drowsiness has been detected in the driver, possibly supported by an acoustic warning signal.

In conventional driver assistance systems 100 which have a monitoring function for the driver 3 on the basis of infrared radiation, the radiation source 7 and radiation receiver 8 must always be arranged such that there is a free view of the face of the driver 3, as illustrated in FIG. 1. In other words, the radiation source 7 is to be arranged such that the infrared radiation can be directed directly onto the driver's face, and the radiation receiver 8 is to be arranged such that the infrared radiation reflected from the face of the driver can be directly received. FIG. 1 shows a case in which both radiation source 7 and radiation receiver 8 are attached to the rear-view mirror 17. This makes it possible, at least with regard to height, to provide a relatively good angle of incidence at the face of the driver 3 and receiving angle for the infrared radiation at the radiation receiver 8, it being understood that the irradiation and the receiving of the infrared radiation always take place from a lateral direction, since the rear-view mirror 17 is always arranged centrally between the driver and front passenger.

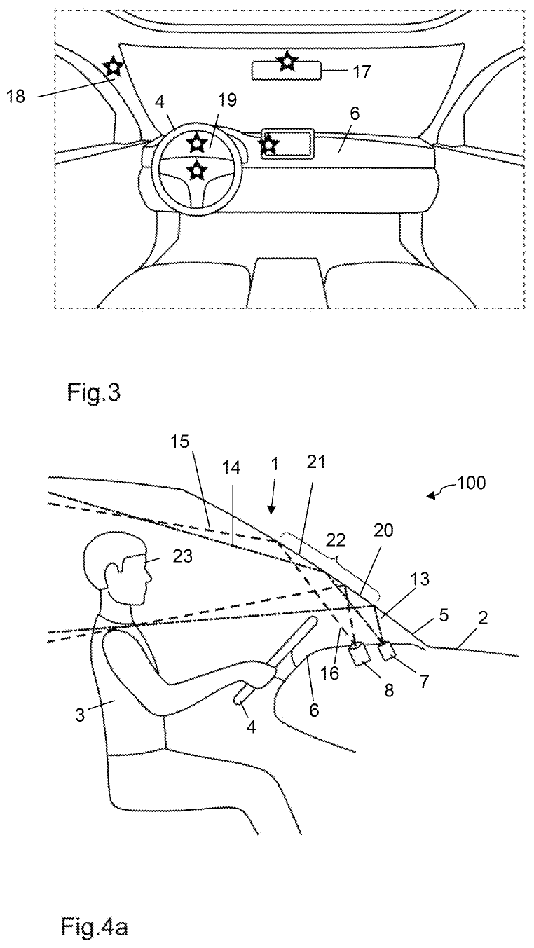

In practice, however, other ways of positioning the radiation source 7 and radiation receiver 8 are quite common, also in order to avoid their conspicuous and easily visible positioning on the rear-view mirror 17. This is illustrated by FIG. 3. Typical positions for the radiation source 7 and radiation receiver 8 are marked by the star-shaped markings, such as in the region of the A-pillar 18, in the middle of the steering wheel 4, on the steering wheel column 19 or in the front region of the console 6.

In comparison to the positioning at the rear-view mirror 17, in the configurations illustrated in FIG. 3, the angle of incidence and receiving angle of the infrared radiation deviates relatively strongly from the perpendicular to the driver's face both in the vehicle transverse direction and in the vehicle vertical direction, which is disadvantageous when determining information about the driver, since in particular the detection of facial expressions and eye movements is then more difficult. In fact, it is all the better possible, the closer the incidence of the infrared radiation is to the perpendicular to the face. A further disadvantage is that the positioning of the radiation source 7 and the radiation receiver 8, due to the necessity of a free view onto the face of the driver 3, usually takes place in such a way that the radiation source 7 and radiation receiver 8 are clearly visible at least for the driver 3 and front passenger. Since these components are usually unsightly, they can also be inserted only poorly into an attractive design for the vehicle interior.

In contrast, the object of the present invention is to provide an improved arrangement comprising a windshield, a radiation source, and a radiation receiver for infrared radiation for a driver assistance system with an infrared-based monitoring function for the driver, which arrangement enables simple and reliable recording of information about the driver. In addition, the radiation source and the radiation receiver for infrared radiation are to be inserted as easily as possible into the design of the vehicle interior and thereby are to be visible to the least extent possible.

According to the proposal of the invention, these and further objects are achieved by an arrangement comprising a windshield, a radiation source, and a radiation receiver for infrared radiation for a driver assistance system with an infrared-based monitoring function according to the independent claim. Preferred embodiments result from the dependent claims.

According to the invention, an arrangement for a driver assistance system for a vehicle, in particular a motor vehicle, with a monitoring function of a driver of the vehicle based on infrared radiation is presented. The arrangement comprises a radiation source for emitting infrared radiation and a radiation receiver for receiving infrared radiation. The arrangement further comprises a laminated pane, serving as a windshield, formed of an outer pane and an inner pane, which are connected to one another over their area by a thermoplastic intermediate layer. The windshield serves in the vehicle for separating an interior from an external environment. Inner pane means the pane facing the interior when in the installed position. Outer pane means the pane facing the external environment when in the installed position. The surfaces or sides of the two individual panes are usually referred to from outside to inside as side I, side II, side III and side IV.

It is essential that the windshield has at least one functional layer which is suitable for reflecting infrared radiation.

In accordance with the invention the radiation source is arranged such that infrared radiation emitted from the radiation source is directed to the functional layer and can be reflected from the functional layer to the face of a driver. Thus, the infrared radiation emitted by the radiation source impinges on the functional layer directly without prior reflection and is reflected therefrom. For ease of reference, the infrared radiation reflected from the functional layer is designated as “first reflection radiation”. Thereby, the first reflection radiation impinges on the face of the driver and can be reflected back in the direction of the functional layer. The first reflection radiation thus impinges directly on the driver's face without further reflection and is reflected therefrom. For ease of reference, infrared radiation reflected from the face of the driver is designated as “second reflection radiation”. The second reflection radiation impinging on the functional layer is then reflected from the functional layer. The second reflection radiation thus impinges directly on the functional layer without further reflection and is reflected therefrom. For ease of reference, the infrared radiation reflected from the functional layer is designated as “third reflection radiation”. Thereby, the radiation receiver is arranged so that the third reflection radiation reflected from the functional layer can be reflected to the radiation receiver and received by the radiation receiver.

The present invention is based on the finding that the functional layer with an infrared-radiation-reflecting property, the actual function of which initially lies in imparting a sun protection effect to the windshield and improving the climate inside the vehicle, can also be used for the reflection of infrared radiation within the scope of the infrared-based monitoring function of the driver assistance system. A particular advantage of the arrangement according to the invention is that the infrared radiation can impinge on the face from the front due to the reflection on the functional layer. The radiation reflected onto the face of the driver can thus contain a radiation component which falls perpendicular to the driver's face. Likewise, the infrared radiation reflected in a corresponding manner from the face can be received, which contains a radiation component which is reflected perpendicularly from the face of the driver. In the prior art, positioning the radiation source and radiation receiver in front of the driver's face would be necessary for this purpose; however, this is prohibited due to an associated interference of the vision through the windshield and also due to legal requirements applicable in many countries. The invention thus presents an innovation which offers substantial advantages over the conventional procedure which are not, in essence, achievable in the prior art. In addition, due to the indirect irradiation of the face, the radiation source and radiation receiver must only be positioned on the functional layer with regard to a suitable reflection of the infrared radiation, which is generally feasible in such a way that it is invisible or at the least practically invisible to the driver and front passenger, for example in the rear region of the console. This is a further great advantage of the invention.

As described above, it is advantageous if the radiation source is arranged such that the first reflection radiation has a radiation component that impinges perpendicularly on the face of the driver. Thereby, it can be advantageous if the first reflection radiation is reflected from a region of the windshield which results at least partially from a horizontal projection of the face of the driver onto the windshield. The first reflection radiation can preferably impinge on the face in a horizontal direction or along a perpendicular to the face of the driver. This enables very good recognition of details of the face of the driver and, in particular, eye movements. Similarly, it is advantageous if the radiation receiver is arranged to receive radiation reflected from the functional layer (i.e., third reflection radiation) based on second reflection radiation, which has a radiation component that has been reflected perpendicularly from the face of the driver. Advantageously, the third reflection radiation is reflected from a region of the windshield which results at least partially from a horizontal projection of the face of the driver onto the windshield. The second reflection radiation can then preferably impinge on the functional layer in a horizontal direction or along a perpendicular to the face of the driver. This also enables very good recognition of details of the face of the driver and, in particular, eye movements.

Preferably, the infrared radiation is reflected only from a first sub-region of the windshield. Equally preferably, the third reflection radiation is reflected only from a second sub-region of the windshield. The first sub-region and the second sub-region may be separate, partially overlapping, or fully overlapping (i.e., identical).

The windshield has at least one functional layer reflecting infrared radiation. The functional layer is disposed on a surface of the outer or inner pane and covers or overlaps the surface of the corresponding pane partially, but preferably over a large area. The term “over a large area” means that at least 50%, at least 60%, at least 70%, at least 75% or preferably at least 90% of the surface of the pane is covered (for example coated) by the functional layer. However, the functional layer can also extend over smaller portions of the surface of the pane, in particular only over that region of the windshield which serves to reflect the infrared radiation (i.e., first sub-region and second sub-region).

The functional layer is preferably transparent to visible light. In an advantageous embodiment, the functional layer is an individual layer or a layer structure of a plurality of individual layers having a total thickness less than or equal to 2 μm, particularly preferably less than or equal to 1 μm. Within the meaning of the present invention, “transparent” means that the overall transmittance of the windshield complies with the legal requirements and preferably has a transmittance for visible light of more than 70% and, in particular, of more than 75%. Accordingly, “opaque” means a light transmission of less than 15%, preferably less than 5%, in particular 0%. The values for light transmission (TL) and reflection (RL) refer (as is usual for automotive glazing) to illuminant A, i.e., the visible portion of sunlight at a wavelength of 380 nm to 780 nm, thus substantially the visible spectrum of solar radiation. Infrared beams are understood to mean beams of a wavelength greater than approximately 800 nm.

The functional layer is preferably a layer with sun protection effect. Such a layer with sun protection effect always has reflective properties in the infrared range and thus in the range of solar radiation, whereby heating of the interior of a vehicle as a result of solar radiation is advantageously reduced. Layers with sun protection effect are well known to a person skilled in the art and typically contain at least one metal, preferably silver, nickel, chromium, niobium, tin, titanium, copper, palladium, zinc, gold, cadmium, aluminum, silicon, tungsten or alloys thereof, and/or at least one metal oxide layer, preferably tin-doped indium oxide (ITO), aluminum-doped zinc oxide (AZO), fluorine-doped tin oxide (FTO, SnO2:F) or antimony-doped tin oxide (ATO, SnO2:Sb). The layer having sun protection effect can comprise a sequence of a plurality of individual layers, in particular at least one metallic layer and dielectric layers, which contain, for example, at least one metal oxide. The metal oxide preferably includes zinc oxide, tin oxide, indium oxide, titanium oxide, silicon oxide, aluminum oxide or the like, along with combinations of one or more thereof. The dielectric material can also contain, for example, silicon nitride, silicon carbide or aluminum nitride.

Silver has become established as a preferred metal for the metal layer, since it has a relatively neutral color effect and also selectively reflects the infrared radiation outside the visible range of solar radiation. The dielectric layers have the task of improving the optical properties of the coated pane via their refractive indices and to protect the metal functional layer from oxidation. Such sun protection layers, which can be produced, for example, with the method of reactive sputtering, are widely used in glazings in vehicles. In most cases, layer systems having two silver functional layers, but also three or four silver functional layers, are used, since their efficiency, i.e., the reflection of the infrared radiation outside the visible range, is greater in relation to transmission of the visible radiation. The silver functional layers are each separated from one another by dielectric layers. Functional layers with sun protection effect are known, for example, from DE102009006062 A1, WO2007/101964 A1, WO2013/104439A1 EP0912455 B1, DE19927683 C1, EP1218307 B1 and EP1917222 B1.

This layer structure is generally obtained by a sequence of deposition processes, which are carried out by a vacuum method, such as magnetic-field-assisted cathode sputtering or by chemical vapor deposition (CVD). Very fine metal layers, which in particular contain titanium or niobium, can also be provided on both sides of a silver layer. The lower metal layer serves as an adhesion and crystallization layer. The upper metal layer serves as a protective and getter layer in order to prevent a change in the silver during the further process steps.

Transparent, electrically conductive layers preferably have a sheet resistance from 0.1 ohm/sq to 200 ohm/sq, particularly preferably from 1 ohm/sq to 50 ohm/sq and very particularly preferably from 1 ohm/sq to 10 ohm/sq.

The thickness of the functional layer with sun protection effect can vary widely and can be adapted to the requirements of the individual case, wherein a layer thickness of 10 nm to 5 μm and, in particular, 30 nm to 1 μm is preferred. The sheet resistance of the functional layer with sun protection effect is preferably from 0.35 ohm/sq to 200 ohm/sq, preferably 0.5 ohm/sq to 200 ohm/sq, very particularly preferably from 0.6 ohm/sq to 30 ohm/sq, and in particular from 2 ohm/sq to 20 ohm/sq.

The functional layer or a carrier film with the functional layer can be arranged on a surface of one of the two panes of the windshield. For example, the functional layer is located on an inner surface of the one or the other pane (i.e., side II or side III). For example, the functional layer is arranged on the inner-side surface of the outer pane (side II). Alternatively, the functional layer can be embedded between two thermoplastic intermediate layers. The functional layer is then preferably applied to a carrier film or carrier pane. The carrier film or carrier pane preferably contains a polymer, in particular polyvinyl butyral (PVB), ethylene vinyl acetate (EVA), polyurethane (PU), polyethylene terephthalate (PET) or combinations thereof.

However, it is also possible for the functional layer with an infrared-beam-reflecting property to be arranged on the outer surface of the inner pane (side IV), for example in the form of a low-emissivity layer, also referred to as a Low-E layer. Such functional layers are known, for example, from WO2013/131667A1. A Low-E layer has the task of reflecting thermal radiation, i.e., in particular IR radiation, which has a greater wavelength than the IR component of solar radiation. At low outside temperatures, the Low-E layer reflects heat back into the interior of the vehicle and reduces the cooling of the interior. At high outside temperatures, the Low-E layer reflects the thermal radiation of the heated laminated pane outwards and reduces the heating of the interior. On the inner side of the inner pane, the Low-E layer particularly effectively reduces the emission of heat radiation of the pane into the interior in summer and the emission of heat into the external environment in winter.

The Low-E layer preferably comprises a layer which contains a transparent conductive oxide (TCO), preferably indium tin oxide, tin oxide doped with antimony or fluorine, and/or zinc oxide doped with gallium and/or aluminum (ZnO:Ga, or ZnO:Al), wherein indium tin oxide is preferred. However, other electrically conductive oxides can be contained, for example fluorine-doped tin oxide (SnO2:F), antimony-doped tin oxide (SnO2:Sb), indium-zinc mixed oxide (IZO), gallium-doped or aluminum-doped zinc oxide, niobium doped titanium oxide, cadmium stannate and/or zinc stannate. Particularly good results with regard to the emissivity are thus achieved. Indium tin oxide is preferably deposited using magnetic-field-assisted cathode sputtering with a target of indium tin oxide. The target preferably contains from 75 wt. % to 95 wt. % indium oxide and from 5 wt. % to 25 wt. % tin oxide and production-related admixtures. The tin-doped indium oxide is preferably deposited under a protective gas atmosphere, for example argon. A small proportion of oxygen can also be added to the protective gas, for example in order to improve the homogeneity of the functional layer. Alternatively, the target may preferably contain at least 75 wt. % to 95 wt. % indium and 5 wt. % to 25 wt. % tin. The indium tin oxide is then preferably deposited with the addition of oxygen as a reaction gas during cathode sputtering.

The Low-E layer also typically comprises dielectric layers, in particular formed of dielectric oxides or nitrides, such as ZnO, SnZnO, AlN, TiO2, SiO2 or Si3N4. The layer of reflective conductive oxide is made anti-reflective above and below by using additional dielectric layers in order to ensure a sufficiently low reflection from the inside.

The interior-side emissivity of the laminated pane is preferably less than or equal to 50%, particularly preferably from 10% to 50%, very particularly preferably from 20% to 35%. Here, interior-side emissivity is the measure that indicates how much heat radiation the pane emits into an interior, for example of a vehicle, in the installed position compared to an ideal heat emitter (a black body). In the sense of the invention, emissivity is understood to mean the normal emissivity at 283 K according to the standard EN 12898. The emissivity of the windshield can be influenced by the thickness of the functional layer of the Low-E layer. The thickness thereof is preferably 40 nm to 200 nm, particularly preferably 60 nm to 150 nm, and very particularly preferably 65 nm to 85 nm, for example approximately 75 nm. In this range for the thickness, particularly advantageous values for the emissivity and a particularly advantageous ability of the Low-E layer to withstand a mechanical transformation such as bending or prestressing without damage are achieved.

The two panes of the windshield preferably contain or consist of glass, particularly preferably flat glass, float glass, quartz glass, borosilicate glass, soda-lime glass, or clear plastics, preferably rigid clear plastics, and in particular polyethylene, polypropylene, polycarbonate, polymethyl methacrylate, polystyrene, polyamide, polyester, polyvinyl chloride and/or mixtures thereof. Suitable glasses are known, for example, from EP 0 847 965 B1.

The thickness of the two panes can vary widely and therefore be adapted to the requirements of the individual case. Preferably, panes with the standard thicknesses of 1.0 mm to 25 mm and preferably of 1.4 mm to 2.1 mm are used. The size of the panes can vary widely and depends upon the use.

The intermediate layer contains or consists of at least one thermoplastic, preferably polyvinyl butyral (PVB), ethylene vinyl acetate (EVA) and/or polyethylene terephthalate (PET). The thermoplastic intermediate layer can, however, also contain, for example, polyurethane (PU), polypropylene (PP), polyacrylate, polyethylene (PE), polycarbonate (PC), polymethyl methacrylate, polyvinyl chloride, polyacetate resin, casting resin, acrylate, fluorinated ethylene propylene, polyvinyl fluoride, and/or ethylene tetrafluoroethylene, or a copolymer or mixture thereof. The thermoplastic intermediate layer can be designed by one or more thermoplastic films arranged one above the other, wherein the thickness of a thermoplastic film is preferably from 0.25 mm to 1 mm, typically 0.38 mm or 0.76 mm.

The windshield can, for example, have a peripheral edge with a width of 2 mm to 50 mm, preferably of 5 mm to 20 mm, which is not provided with the functional layer. The functional layer advantageously does not have any contact with the atmosphere and is protected from damage and corrosion, for example, in the interior of a windshield by the thermoplastic intermediate layer.

The two individual panes of the windshield are preferably connected during the lamination process under the effect of heat, vacuum, and/or pressure. Methods known per se for producing a laminated glass pane can be used. For example, so-called autoclave methods can be carried out at an elevated pressure of approximately 10 bar to 15 bar and at temperatures of 130° C. to 145° C. for approximately 2 hours. Vacuum-bag or vacuum-ring methods known per se operate, for example, at approximately 200 mbar and 80° C. to 110° C. The two panes and the thermoplastic intermediate layer can also be pressed in a calender between at least one pair of rollers to form a laminated pane. Systems of this type for the production of laminated glass panes are known and usually have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more heatable and evacuable chambers, in which the two panes are laminated within, for example, approximately 60 minutes at reduced pressures of 0.01 mbar to 800 mbar and temperatures from 80° C. to 170° C.

The invention further extends to a driver assistance system with an infrared-based monitoring function for the driver of a vehicle, which comprises an arrangement according to the invention. The driver assistance system further comprises at least one actuator and/or at least one signal output device, along with an electronic control device that is configured to determine information about the driver on the basis of an output signal of the radiation receiver and to output an electrical signal to the at least one actuator for performing a mechanical action and/or to the at least one signal output device for outputting a visual and/or acoustic signal on the basis of the determined information about the driver.

Furthermore, the invention extends to a method for monitoring a driver of a vehicle, in particular for implementation in a driver assistance system according to the invention, said method comprising the following steps:
a) emitting infrared radiation onto a functional layer reflecting infrared radiation of a windshield, such that infrared radiation reflected from the functional layer impinges on the face of the driver as first reflection radiation, wherein the first reflection radiation from the face of the driver impinges on the functional layer as second reflection radiation and is reflected from the functional layer as third reflection radiation,
b) receiving the third reflection radiation,
c) determining information about the driver,
d) performing an action and/or outputting a visual and/or acoustic signal on the basis of the determined information about the driver.

Furthermore, the invention extends to the use of the arrangement according to the invention in a driver assistance system of a vehicle, in particular motor vehicle, for transport on land, on water, or in the air.

The various embodiments of the invention may be implemented individually or in any combinations. In particular, the features mentioned above and to be explained below can be used not only in the specified combinations, but also in other combinations or alone without departing from the scope of the present invention.

The invention is explained in more detail below with reference to an exemplary embodiment, wherein reference is made to the accompanying figures. Elements that are identical or have the same effect are provided with the same reference signs. In a simplified, not-to-scale representation:

FIG. 1 shows a schematic view of the front part of a vehicle with a driver with a conventional driver assistance system for infrared-based monitoring of the driver,

FIG. 2 shows a schematic view of the functional blocks of the conventional driver assistance system of FIG. 1,

FIG. 3 shows a schematic representation of different positions of radiation source and radiation receiver,

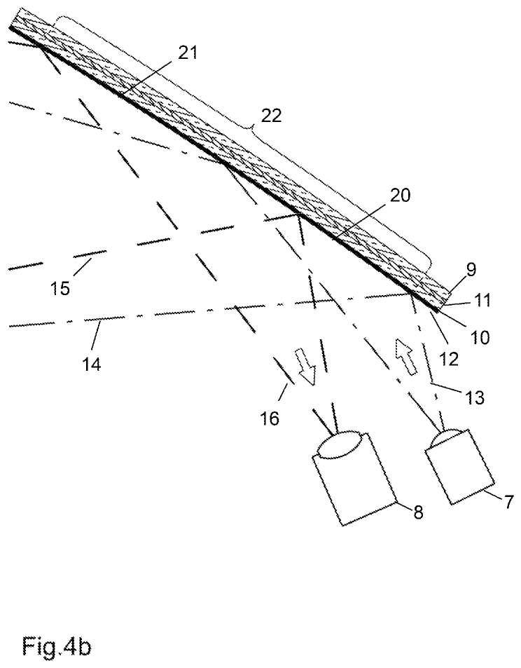

FIG. 4a shows a schematic view of the front part of a vehicle with driver with arrangement and driver assistance system according to the invention for infrared-based monitoring of the driver,

FIG. 4b shows an enlarged schematic view of the arrangement according to the invention,

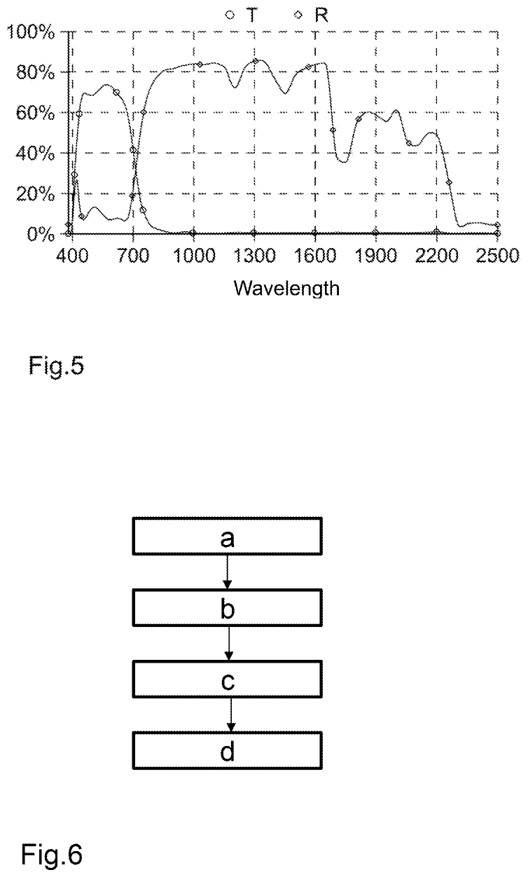

FIG. 5 shows a graph illustrating the transmission and reflectivity of the windshield of FIG. 4b with Low-E layer, and

FIG. 6 shows a flowchart illustrating the method according to the invention for infrared-based monitoring of a driver of a vehicle.

FIGS. 1 to 3 have already been explained at the outset. Reference is now made to FIGS. 4a and 4b, in which an arrangement according to the invention is shown by which the disadvantages of the conventional driver assistance system with infrared-based monitoring of the driver, which were presented at the outset, can be avoided.

The arrangement according to the invention, which is denoted overall by the reference numeral 1, is provided for use in a driver assistance system, as has been described in conjunction with FIGS. 1 to 3. The driver assistance system comprises in particular the same functional components as a conventional driver assistance system 100, which has been described in conjunction with FIG. 2, wherein, in contrast thereto, the infrared radiation emitted by the radiation source is directed toward the functional layer, from there reflected onto the face of the driver, reflected from the face of the driver onto the functional layer and reflected from the functional layer in the direction of the radiation receiver and is received by the radiation receiver. In structural terms, the driver assistance system 100 according to the invention differs from the conventional driver assistance systems 100 only in the structural implementation of block I of FIG. 2. The structural implementation of the blocks II and Ill can take place in a conventional manner, wherein reference is made to the above statements.

FIG. 4a, analogously to FIG. 1, schematically shows a driver 3 at the steering wheel 4 of a vehicle 2, of which only the front part including the windshield 5 and the console 6 is shown for the sake of clarity. FIG. 4b shows an enlarged schematic representation of the arrangement 1 according to the invention.

The arrangement 1 according to the invention comprises a windshield 5 of a vehicle 2 which has an outer pane 9 and an inner pane 10 which are fixedly connected to one another by a thermoplastic intermediate layer 11. On side IV, i.e., on the pane surface of the inner pane 10 pointing toward the vehicle interior, a low-emissivity, functional layer 12 reflecting infrared radiation is applied, i.e., the functional layer 12 is a Low-E layer. It would also be conceivable that the functional layer 12 has a sun protection effect and is arranged between the two panes 9, 10.

The arrangement 1 furthermore comprises a radiation source 7 and a radiation receiver 8 which, as shown schematically in FIG. 4b, can be arranged next to one another, but can be installed in the same assembly. Both the radiation source 7 and the radiation receiver 8 are installed here, for example, in the rear region of the console 6, where they are practically invisible to the vehicle occupants. The radiation source 7 is positioned and oriented such that the infrared radiation is directed onto the side IV of the inner pane 10 and is reflected there from the functional layer 12 as first reflection radiation 14 toward the face of the driver 3. The first reflection radiation 14 is reflected from the functional layer 12 only in a first sub-region 20 of the windshield 5 and impinges from the front onto the face of the driver 3. The first reflection radiation 14 has a radiation component that impinges on the face of the driver 3 perpendicularly, i.e., in the horizontal direction, if the vehicle 2 is standing on a flat surface.

From the face of the driver 3, the first reflection radiation 14 is reflected as second reflection radiation 15 in the direction of the functional layer 12. The second reflection radiation 15 has a radiation component that is reflected perpendicularly from the face of the driver 3, i.e., in the horizontal direction, if the vehicle 2 is standing on a flat surface. From the functional layer 12, the second reflection radiation 15 is reflected to the radiation receiver 8 as third reflection radiation 16. The third reflection radiation 16 is reflected only from a second sub-region 21 of the windshield 5. The first sub-region 20 and the second sub-region 21 partially overlap here, but can also fully overlap (i.e., be identical) or not overlap. The first sub-region 20 and the second sub-region 21 together form the reflection region 22 of the windshield 5. The radiation receiver 8 is directed to the side IV and can receive the third reflection radiation 16 reflected from the functional layer 12.

The first sub-region 20 preferably corresponds to a region of the windshield 5 that faces the face of the driver at least in portions, i.e., a region that results from a horizontal projection of the face 23 of the driver 3 onto the windshield 5. Likewise, the second sub-region 21 preferably corresponds to a region of the windshield 5 that faces the face of the driver at least in portions, i.e., a region that results from a horizontal projection of the face 23 of the driver 3 onto the windshield 5.

Based on the driver data recorded in this way, information about the driver can be determined in a particularly reliable manner, since, on the one hand, the first reflection radiation 14 reflected from the functional layer 12 has a radiation component that impinges on the face 23 of the driver perpendicularly, and, on the other hand, the third reflection radiation 16 reflected from the functional layer 12 has a radiation component that was reflected perpendicularly from the face 23 of the driver 3. Thus, features of the face, such as facial expressions and eye movements, can be determined particularly well and reliably. In addition, the radiation source 7 and the radiation receiver 8 can be arranged in the rear region of the console 6, such that they can be easily integrated into the interior of the vehicle and do not interfere with the design of the vehicle interior.

For a laminated pane as shown in FIG. 4a, the transmission and reflection of incident radiation was determined. Here, the outer pane 9 consisted of soda-lime glass and had a thickness of 2.1 mm and the inner pane 10 likewise consisted of soda-lime glass and had a thickness of 1.6 mm. The two panes 9, 10 were laminated by a PVB film with a thickness of 0.76 mm. The functional layer 12 applied to side IV was a Low-E layer with two silver layers separated from one another by dielectric layers.

FIG. 5 shows the transmission spectrum of such a windshield 5, wherein the transmitted radiation component T and the reflected radiation component R are each shown in % of the incident radiation as a function of the wavelength. As can be seen, the functional layer 12 has a high transmission with visible light, but a very low reflectivity (<10%), whereas the transmission is very low in the infrared wavelength range and the reflectivity is high. The functional layer 12 can thus be used to reflect infrared radiation onto the face of the driver 3 and to reflect again the infrared radiation reflected from the face of the driver 3.

FIG. 6 illustrates the method for monitoring a driver.

The method comprises at least the following method steps:
a) emitting infrared radiation 13 onto a functional layer 12 reflecting infrared radiation with sun protection effect of a windshield 5, such that infrared radiation reflected from the functional layer 12 impinges on the face of the driver 3 as first reflection radiation 14, wherein the first reflection radiation 14 from the face of the driver 3 impinges on the functional layer 12 as second reflection radiation 15 and is reflected from the functional layer 12 as third reflection radiation 16,
b) receiving the third reflection radiation 16,
c) determining information about the driver 3,
d) performing an action and/or outputting a visual and/or acoustic signal on the basis of the determined information about the driver 3.

From the above statements, it is apparent that the arrangement according to the invention for a driver assistance system of a vehicle advantageously allows for a very precise determination of characteristics of the face of a driver, in particular the detection of facial expressions and eye movements. In contrast to conventional systems, the infrared radiation impinging on the face can have a radiation component which impinges perpendicularly on the face of the driver. Likewise, it is possible to detect infrared radiation reflected from the face which has a radiation proportion that is reflected perpendicularly from the face of the driver. In addition, both radiation source and radiation receiver can be integrated into the technical environment such that they are practically invisible to the vehicle occupants, which, for the technical implementation of the arrangement according to the invention, also brings advantages with regard to the design of the vehicle interior.

### LIST OF REFERENCE SIGNS

1 Arrangement
2 Vehicle
3 Driver
4 Steering wheel
5 Windshield
6 Console
7 Radiation source
8 Radiation receiver
9 Outer pane
10 Inner pane
11 Intermediate layer
12 Functional layer
13 Infrared radiation
14 First reflection radiation
15 Second reflection radiation
16 Third reflection radiation
17 Rear-view mirror
18 A-pillar
19 Steering wheel column
20 First sub-region
21 Second sub-region
22 Reflection region
23 Face
100 Driver assistance system

1. An arrangement for a driver assistance system of a vehicle, comprising:
a radiation source for emitting infrared radiation,
a radiation receiver for receiving infrared radiation,
a windshield formed of an outer pane and an inner pane which are connected to one another via a thermoplastic intermediate layer, wherein the windshield has at least one functional layer reflecting infrared radiation,
wherein the radiation source is arranged such that infrared radiation is reflectable from the functional layer as first reflection radiation onto a face of a driver, the first reflection radiation is reflectable from the face of the driver as second reflection radiation onto the functional layer, and wherein the radiation receiver is arranged such that the second reflection radiation reflected from the functional layer as third reflection radiation is reflectable to the radiation receiver and received by the radiation receiver.

2. The arrangement for a driver assistance system of a vehicle according to claim 1, wherein the radiation source is arranged such that the first reflection radiation has a radiation component which can impinge perpendicularly on the face of the driver.

3. The arrangement for a driver assistance system of a vehicle according to claim 1, wherein the radiation receiver is arranged such that third reflection radiation is receivable as reflected second reflection radiation, wherein the second reflection radiation has a radiation component which was reflected perpendicularly from the face.

4. The arrangement for a driver assistance system of a vehicle according to claim 1, wherein the radiation source is arranged such that the first reflection radiation is reflected from a first sub-region of the windshield which results at least partially from a horizontal projection of the face of the driver onto the windshield.

5. The arrangement for a driver assistance system of a vehicle according to claim 1, wherein the radiation receiver is arranged such that the third reflection radiation is reflected from a second sub-region of the windshield which results at least partially from a horizontal projection of the face of the driver onto the windshield.

6. The arrangement for a driver assistance system of a vehicle according to claim 1, wherein the functional layer is arranged on a side of the inner pane facing the interior of the vehicle.

7. The arrangement for a driver assistance system of a vehicle according to claim 6, wherein the functional layer is a low-emissivity functional layer.

8. The arrangement for a driver assistance system of a vehicle according to claim 1, wherein the functional layer is arranged on a surface of the inner pane or outer pane facing the respective other pane.

9. The arrangement for a driver assistance system of a vehicle according to claim 8, wherein the functional layer is a functional layer with sun protection effect.

10. The arrangement for a driver assistance system of a vehicle according to claim 1, wherein the functional layer is arranged over a large area on the outer pane or inner pane.

11. The arrangement for a driver assistance system of a vehicle according to claim 1, wherein the functional layer is arranged only on a first sub-region which serves to reflect the first reflection radiation, and/or wherein the functional layer is arranged only on a second sub-region which serves to reflect the third reflection radiation.

12. The arrangement for a driver assistance system of a vehicle according to claim 1, wherein the functional layer has one, two, three, four or more silver functional layers which are separated from one another by dielectric layers.

13. A driver assistance system with an infrared-based monitoring function for drivers of a vehicle, comprising:
an arrangement according to claim 1,
at least one actuator and/or at least one signal output device,
an electronic control device that is configured to determine information about the driver on the basis of an output signal of the radiation receiver, and to output an electrical signal to the at least one actuator for performing a mechanical action and/or to the at least one signal output device for outputting a visual and/or acoustic signal on the basis of the determined information.

14. A method for monitoring a driver of a vehicle, comprising:
a) emitting infrared radiation onto a functional layer reflecting infrared radiation of a windshield, such that infrared radiation reflected from the functional layer impinges on the face of the driver as first reflection radiation, wherein the first reflection radiation from the face of the driver impinges on the functional layer as second reflection radiation and is reflected from the functional layer as third reflection radiation,
b) receiving the third reflection radiation,
c) determining information about the driver,
d) performing an action and/or outputting a visual and/or acoustic signal on the basis of the determined information about the driver.

15. A method comprising providing the arrangement according to claim 1 in a driver assistance system with infrared-based monitoring of a driver of a vehicle for transport on land, water or in the air.
